(19) United States
(12) Patent Application Publication
(10) Pub. No.: US 2009/0075543 A1
(43) Pub. Date: Mar. 19, 2009

(54) MALLEABLE POLYMER MONOFILAMENT FOR INDUSTRIAL FABRICS

(75) Inventors: Heping Zhang, Summerville, SC (US); Craig Valentine, Summerville, SC (US); Matthias Hoehsl, Reutlingen (DE)

Correspondence Address: GREENBLUM & BERNSTEIN, P.L.C., 1950 ROLAND CLARKE PLACE, RESTON, VA, 20191, US

(73) Assignee: VOITH PATENT GmbH, Heidenheim (DE)

(21) Appl. No.: 11/856,497

(22) Filed: Sep. 17, 2007

(51) Int. Cl. D03D 15/00; C08L 35/02

(52) U.S. Cl. 442/199; 525/225; 139/420 A

(57) ABSTRACT

The present invention relates to malleable polymer monofilaments that show shape malleability under heat and stress. The monofilaments can be used in closely woven industrial fabrics, especially in paper machine fabrics, as weft materials that protect load bearing warp yarns for better wear resistance.

### BACKGROUND OF THE INVENTION

1. Field of the Invention

This invention relates to malleable polymer monofilaments for industrial fabrics. In particular, the malleable polymer monofilaments can be used as weft material of a woven structure, and the malleable polymer monofilaments can include at least a two-phase polymer including at least polyethylene terephthalate (PET) and an ethylene copolymer.

2. Background and Related Information

Industrial fabrics, especially papermaking fabrics; are typically, but not-exclusively, made of a woven structure using polymer yarns in the weft and warp direction. To improve the smoothness and the printability of a paper sheet produced on a papermaking fabric it is desirable to increase the smoothness and the contact area of the paper contacting surface of the papermaking fabric. Especially for high speed applications it is further desirable to increase the smoothness of the wear side of the papermaking fabric in order to improve the aerodynamic performance of the fabric.

The smoothness of the paper contacting surface can be improved by increasing the yarn density. However, this results in increased manufacturing costs and reduced permeability of the fabric. Further, the smoothness can be improved by using profiled monofilament yarns having flat surfaces. When using the flat shaped yarns, such as warp yarns in float weave designs, the flat warp yarns provide greater surface contact area resulting in a larger impression against the paper sheet. For graphic and fine paper grades the large impression leads to undesirable sheet marking in the paper.

The smoothness of the paper contacting surface can also be improved by decreasing the monofilament diameter. However, small diameter monofilaments can reduce the overall strength of the fabric leading to wearing problems, and thin fabrics can cause instability on the machines. It has been shown that higher diameter monofilaments can increase strength of resultant fabrics reducing wearing problems, but the reduced contact points sand the surface of the product contacting the fabric causing undesirable marks. In addition, for graphics, it is common to calendar the fabric to flatten, but this is temporary due to recovery, and is also detrimental to the yarn, and therefore not effective.

Therefore, in view of the above problems, a structure and a method to bring the weft yarns as well as the warp yarns into the paper contacting surface of the papermaking fabric to increase the contact area and the smoothness of the fabric is needed to provide better quality products.

### SUMMARY OF THE INVENTION

In forming fabrics, in order to prevent stretching on a paper machine, warp monofilaments are typically highly oriented to provide a high modulus. Polyethylene terephthalate (PET) is the material of choice for this application due to it's price/performance characteristics. However, when highly oriented, PET monofilaments may become more prone to fibrillation when fatigued. Thus, it was quickly found that these types of filaments needed to resist stretching resulting in quick wear when running over the wear surface of a forming section. Designers solved this problem by effectively “burying” the warp beneath the weft yarn so that it is essentially the weft yarns that run in contact with the wear surfaces on the back side (i.e., machine side) of the fabric. The life of a forming fabric is essentially determined by the time taken to reach the warp in the fabric. Therefore, it was found that the life of the fabric could be improved if the burial of the warp within the structure could be increased.

In addition, modern paper machines for fine and graphic papers are requiring finer surfaces to improve print quality and eliminate wire marking. Thus, a material that can increase the surface contact with the paper could then provide better paper quality.

The present invention provides a yarn for use in industrial fabrics such that when in used in the weft direction, the yarn of the present invention provides increased deformation leading to increased warp burial in the fabric. This increase in the depth of burial will have a direct impact on fabric life by providing increasing wear volume before the warp is impacted.

The present invention also provides a yarn for use in industrial fabrics such that when the yarn is used on the face side in warp and weft directions, the monofilaments can deform under the heat and pressure of the heat setting process, providing a flat surface to the round monofilament giving higher surface contact and better paper quality. This is an alternative way to achieve a calendered surface while using conventional heat setting techniques.

Thus, the present invention provides a yarn for an industrial fabric which includes a polymeric material blend having at least a first phase and a second phase, where the polymeric material blend exhibits shape malleability under heat from approximately 80° C. to approximately 300° C.

In some embodiments, the first phase of the polymeric material blend contains a melting point higher than the melting point of the second phase of the polymeric material blend.

In some embodiments, the first phase of the polymeric material blend contains approximately 80 to approximately 100 wt. % polyethylene terephthalate, and the second phase of the polymeric material blend contains from approximately 0 to approximately 40 wt. % of an ethylene copolymer.

In some embodiments, the yarn further includes at least one compatibilizer present in the amount of from approximately 0.01 wt. % to approximately 10 wt. %. The compatibilizer can include at least one of Ethylene Methyl Acrylate Copolymer (EMA), Ethylene Butyl Acrylate Copolymer (EBA), Ethylene-g-Maleic Anhydride Copolymers, or Ethylene-g-Glycidal Methacrylate.

In some embodiments, the yarn further includes at least one stabilizer present in the amount of from approximately 0.01 wt. % to approximately 10 wt. %. The stabilizer can include at least one carbodiimide compound.

The present invention also provides an industrial fabric including warp yarns and weft yarns interwoven with each other, wherein at least the weft yarns are constructed of a polymeric material blend having at least a first phase and a second phase such that the polymeric material blend exhibits shape malleability under heat from approximately 80° C. to approximately 300° C. According to the invention, the industrial fabric can preferably be a forming fabric.

In some embodiments, the industrial fabric further provides for a first phase of the polymeric material blend having a melting point higher than the melting point of the second phase of the polymeric material blend.

In some embodiments, the first phase of the polymeric material blend of industrial fabric contains from approximately 60 to approximately 100 wt. % polyethylene terephthalate, and the second phase of the polymeric material blend contains from approximately 0 to approximately 40 wt. % of ethylene copolymer.

In some embodiments, the industrial fabric is constructed to have a warp burial on a machine side of the industrial fabric of from approximately 0.01 mm to approximately 0.99 mm after a heat-set treatment of the industrial fabric from a temperature of from approximately 80° C. to approximately 300° C.

In some embodiments, the industrial fabric is constructed to have a warp burial on a machine side of the industrial fabric of from approximately 0.1 mm to approximately 0.7 mm after a heat-set treatment of the industrial fabric from a temperature of from approximately 80° C. to approximately 300° C.

In some embodiments, the industrial fabric is constructed to have a warp burial on a machine side of the industrial fabric of from approximately 0.15 mm to approximately 0.6 mm after a heat-set treatment of the industrial fabric from a temperature of from approximately 80° C. to approximately 300° C.

In some embodiments, the industrial fabric is constructed to have a warp burial on a paper side of the industrial fabric of from approximately 0.01 mm to approximately 0.5 mm after a heat-set treatment of the industrial fabric from a temperature of from approximately 80° C. to approximately 300° C. For graphical paper, there may be preferably no warp burial on the paper side.

In some embodiments, the industrial fabric is constructed to have a warp burial on a paper side of the industrial fabric of from approximately 0.1 mm to approximately 0.4 mm after a heat-set treatment of the industrial fabric from a temperature of from approximately 80° C. to approximately 300° C. For example, this may be case for tissue grades.

The present invention further provides a method of making an industrial fabric by providing warp yarns and weft yarns and interweaving them with respect to each other, where at least the weft yarns are constructed of a polymeric material blend having at least a first phase and a second phase such that the polymeric material blend exhibits shape malleability under heat from approximately 80° C. to approximately 300° C.

In some embodiments, the method of making an industrial fabric provides that the first phase of the polymeric material blend contains a melting point higher than the melting point of the second phase of the polymeric material blend.

In some embodiments, the method of making an industrial fabric provides that the first phase of the polymeric material blend includes from approximately 60 to approximately 100 wt. % polyethylene terephthalate, and the second phase of the polymeric material blend includes from approximately 0 to approximately 40 wt. % of ethylene copolymer.

### BRIEF DESCRIPTION OF THE DRAWINGS

The present invention is further described in the detailed description which follows, in reference to the noted plurality of drawings by way of non-limiting examples of preferred embodiments of the present invention, in which like numerals represent like elements throughout the several views of the drawings, and wherein:

FIG. 1 depicts an embodiment of the present invention showing a cross sectional view of a fabric taken in the transverse, or weft wise direction;

FIG. 2(a) depicts a conventional control sample showing warp burial properties using a PET weft monofilament; and

FIG. 2(b) depicts an embodiment of the present invention showing warp burial properties using a malleable weft monofilament.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

According to one embodiment of the present invention the polymeric material is a polymer blend wherein the first phase includes a first polymer component and wherein the second phase includes a second polymer component and wherein the first and the second polymer component are immiscible. By blending immiscible polymer compounds most of the properties, such as the melting temperature of each polymer compound, will be substantially maintained.

According to some embodiments of the present invention, the first and the second phase are of the same material and differ in their state of aggregation.

According to some embodiments, the first polymer component comprises a polyethylene terephthalate (PET)-based polymer. Further, the first component can include any of the following, either alone or blended with one or more of each other: homopolymers and copolymers of the polyesters, homepolymers and copolymers of polyamides, and Polyphenylene Sulfide (PPS).

According to some embodiments, the second copolymer component comprises an ethylene copolymer. Further, the second component can include any of the following, either alone or blended: polyolefins, polyamides and fluoropolymers.

It should be noted that the following examples and descriptions provide details of a PET-based polymer for the first polymer component, and an ethylene copolymer for the second polymer component, thereby making a two phase system. However, the present invention contemplates any two or more phase system which provides a malleable and deformable yarn, preferably provided in the weft direction of a fabric, so long as the polymer system (i.e., two or more phases) exhibits shape malleability under heat from approximately 80° C. to approximately 300° C.

In one embodiment of the present invention, the polymer blend is processed by incorporating at least one suitable compatibilizer. Without a suitable compatibilizer the mechanical properties, such as toughness of the yarn produced is reduced. Further, for immiscible polymer blends the so called “die swell” during extrusion increases, which effects the controllability of the extruded yarn diameter.

It has been found that the best results, in regard to processability, can be achieved if the at least one compatibilizer is included in an amount of approximately 0.01% to approximately 10% by weight, preferably in an amount of approximately 0.1% to approximately 5% by weight.

There are different types of compatibilizers that are suitable for the polymer blend of the present invention. According to an embodiment of the present invention at least one compatibilizer is a physical compatibilizer. A physical compatibilizer is based on the principle that components of the compatibilizer are miscible with each component/phase of the blend. Thus, in such embodiments, the compatibilizer acts as a polymeric surfactant.

According to a further embodiment of the present invention the physical compatibilizer can be any of the following: Ethylene Methyl Acrylate Copolymer (EMA), and Ethylene Butyl Acrylate Copolymer (EBA). By way of example, the blend may include the polymer components PET, ethylene copolymer, and the compatibilizer EMA. In this case the ethylene component of the compatibilizer is miscible with the ethylene copolymer and the methacrylate component of the compatibilizer is miscible with the PET.

A suitable compatibilizer also can be a reactive compatibilizer. This method of compatibilization may rely on the chemical reaction between the functional group that is grafted onto the PE and the end groups of the PET. This results in the in-situ formation of a PET/PE copolymer, which then acts as a physical compatibilizer for the blend. The suitable reactive compatibilizer can be any of the following: Ethylene-g-Maleic Anhydride Copolymers, Ethylene-g-Glycidal Methacrylate.

Further, the polymer blend can include at least one suitable stabilizer. A stabilizer, for example, is added to design yarns with the ability to withstand severe conditions such as high temperature and/or high humidity. According to one embodiment of the present invention, the at least one stabilizer is a hydrolysis stabilizer. Hydrolysis stabilizers are added to the blend to generate yarns for use under high humidity conditions. The hydrolysis stabilizer can be a carbodiimide compound of either monomeric, polymeric or a combination composition.

According to a further embodiment of the present invention the at least one stabilizer can be an anti-oxidation stabilizer. Anti-oxidation stabilizers are added to the blend to generate yarns for use under high temperature conditions.

It has been found that the best results in retaining the properties of the blend can be achieved if the at least one stabilizer is included in an amount of approximately 0.01% to approximately 10% by weight, preferably in an amount of approximately 0.5% to approximately 5% by weight.

Further, in some embodiments, the yarn is preferably a monofilament yarn, but also can be a multifilament yarn.

The yarn shape, according to some embodiments of the present invention, can be round or profiled, with, for example, chamfered edges.

According to some embodiments of the present invention, the monofilament yarn of the has a diameter in the range of approximately 0.05 mm to approximately 2.0 mm. Moreover, on the paper side, yarn diameter can preferably be in a range from about 0.05 mm-0.2 mm, wherein the diameter of machine side yarn may be preferably between about 0.17-1.0 mm.

According to some embodiments of the present invention, it has been found that the paper contacting surface of the fabric using at least the monofilament yarn in the weft direction, has an enhanced smoothness over the paper contacting surfaces when compared to prior art paper making fabrics, thereby leading to less sheet marking.

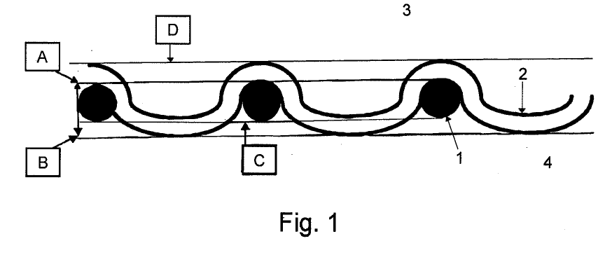

Referring to the drawings wherein like numerals represent like elements, FIG. 1 shows a cross-sectional diagram which cuts through the warp yarns of a fabric. Thus, the fabric is formed by warp yarns 1 and weft yarns 2 that are at an oblique angle with respect to each other. The warp burial is defined as the perpendicular distance between a contact surface of a weft yarn 2 and a first surface of the warp yarn 1. Thus, in FIG. 1, if the fabric in FIG. 1 were a fabric used in a paper making machine, and side 4 were to represent a machine side of the fabric, and side 3 were to represent a paper side of the fabric, the warp burial would be the distance between B and C, and the total warp burial would be the distance between A and B.

According to some embodiments, when side 4 is the machine side, and side 3 is the paper side, the warp burial is the distance between B and C, and the total warp burial would be the distance between A and B. Thus, the present embodiment contemplates a warp burial (B to C) of from approximately 0.01 mm to approximately 0.99 mm, it can be from 0.1 mm to approximately 0.7 mm. The present embodiment also contemplates a total warp burial (B to A) from approximately 0.15 mm to approximately 1.35 mm after a heat-set treatment of the industrial fabric from a temperature of from approximately 80° C. to approximately 300° C.

Likewise, the present invention contemplates a fabric including warp yarns 1 and weft yarns 2 where side 4 can represent the paper side, and side 3 can represent the machine side, the warp burial is the distance between B and C, and the total warp burial would be the distance between A and B.

According to some embodiments, when side 4 is the paper side, and side 3 is the machine side, the warp burial is the distance between B and C, and the total warp burial would be the distance between A and B. Thus, the present embodiment contemplates a warp burial (B to C) of from approximately 0.01 mm to approximately 0.5 mm. The present embodiment also contemplates a total warp burial (B to A) from approximately 0.2 mm to approximately 0.9 mm.

According to some embodiments, the malleable monofilament yarn of the present invention can be used in the weft direction of a fabric, and can provide increased deformation leading to increased warp burial in the fabric.

It should be noted that according to some embodiments of the present invention, an increased depth of burial of the warp will have a substantial impact on fabric life by providing increased wear volume before the warp is impacted (i.e., by breaking and/or increased sheet marking).

According to some embodiments of the present invention, the malleable monofilament yarn of the present invention can be used on the face side of a fabric in warp and weft directions, or in only weft directions. By way of example, the malleable yarns on the paper side can be weft yarns or weft and warp yarns, wherein the yarns on the machine side can be weft yarns.

Thus, according to some embodiments, when the malleable monofilament yarn of the present invention is used in the weft direction of a fabric including warp and weft yarns, these monofilaments during weaving and subsequent heat set (e.g., heat and tension), the weft materials deform to adapt to the shape of mesh interstices and the warp (i.e., load bearing yarn) imbeds into the weft yarns (as depicted, for example, in FIG. 1). Thus, a fabric providing a flat surface having higher surface contact and better paper quality results.

### EXAMPLES

TABLE 1

| | Sample | | | |
|---|---|---|---|---|
| | Reference | Sample 1 | Sample 2 | Sample 3 |
| PET (wt %) | 100% | 91% | 92% | 91.75% |
| Ethylene copolymer 1 (wt %) | | 8% | | |
| Ethylene copolymer 2 (wt %) | | | 8% | 8% |
| Compatibilizer (wt %) | | 1% | | 0.25% |
| Melt Processing Temp (° C.) | 280 | 280 | 285 | 285 |
| Melt viscosity indicator (psi) | 400 | 220 +/− 50 | 200 +/− 10 | 290 +/− 50 |
| MONOFILAMENT PROPERTIES | | | | |
| Monofilament diameter (mm) | 0.45 | 0.45 | 0.45 | 0.45 |
| Tensile breaking strength (lbs.) | 13 | 12 | 13 | 13 |
| Elongation at break (%) | 44 | 45 | 43 | 43 |
| Loop tenacity (g/den) | 4.5 | 5.5 | 5.8 | 4.9 |
| Loop elongation (%) | 30 | 29-43 | 37-49 | 23-40 |
| Loop toughness (g/den) | 0.8 | 1.0-1.7 | 1.4-2.1 | 0.65-1.50 |
| Free shrinkage at 400° F. (%) | 10 | 10.5 | 8.5 | |
| Wear failure at 850 g sample load | 3300 | 4000 | 7000 | 9000 |
| (cycles) | | | | |

Table 1 shows a comparison between a standard PET monofilament weft yarn (Reference) and monofilament weft yarns according to the invention (Sample 1 to Sample 3) each having the same yarn diameter (0.45 mm) as the reference yarn.

As can be seen in Table 1, the weft yarns of Samples 1 to 3 are made from a combination of polyethylene terephthalate (PET), ethylene copolymer, and optionally a compatibilizer. As can be seen in Table 1, the Reference yarn contains only PET. The yarn of Sample 1 contains PET in combination with ethylene copolymer 1 (composed of LPDE (low density polyethylene) and 20 wt % methyl acrylate), in addition to a compatibilizer (composed of ethylene maleic anhydride copolymers). The yarn of Sample 2 contains PET in combination with ethylene copolymer 2 (composed of the same materials as in Sample 1 but with different ratio of methyl acrylate that is 30 wt %). The yarn of Sample 3 contains PET in combination with ethylene copolymer 2 (composed of the same materials as in Sample 1 but with different ratio of methyl acrylate that is 30 wt %), in addition to a compatibilizer (composed of ethylene maleic anhydride copolymers).

In some embodiments, the warp yarns which can be combined with the weft yarns described in Table 1 to form an industrial fabric can be made from PET or PET and ethylene copolymers. Ethylene copolymers include, but are not limited to, random copolymers of ethylene/acrylic ester, or copolymers of ethylene and methyl acrylate. Examples of commercially available ethylene copolymers include, but are not limited to, ENTIRA™ Strong 1008, a copolymer of ethylene and methyl acrylate (sold by E.I. DuPont de Nemours and Company).

In addition, as can be see in Table 1, Samples 1 to 3 contain weft yarns according to the present invention, contain significantly higher wear failure values (i.e., the number of cycles until failure) as compared to the reference yarn.

TABLE 2

| | Fabric with PET weft | Fabric with |
|---|---|---|
| | (Reference) | Malleable Weft |
| New fabric thickness (inch) | 0.0468 | 0.0477 |
| Fabric thickness after being | 0.0394 | 0.0366 |
| sanded (inch) | | |
| Fabric thickness reduction | 0.0074 | 0.0111 |
| before warp yarn was | | |
| exposed (inch) | | |

Table 2 shows a comparison between a fabrics using standard PET monofilament yarn (Reference) and fabrics using malleable monofilament weft yarns according to the invention. As shown in Table 2 above, the fabric with the malleable bottom weft yarn has to be worn approximately 30% more before the warp yarn can be exposed.

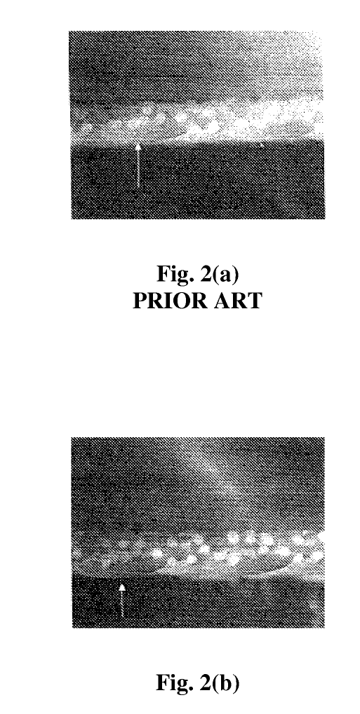

FIGS. 2(a) and 2(b) depict the test samples referred to in Table 2, wherein the warp burial properties are compared, with FIG. 2(a) depicting a reference sample, and FIG. 2(b) depicting a fabric with a malleable weft of an embodiment of the present invention.

FIG. 2(a) shows a fabric with a PET weft, and FIG. 2(b) shows a fabric with a malleable weft. The fabric in FIG. 2(b) shows that the malleable weft adapted to conform with the shape of interstices to thereby protect the load bearing warp yarns more than the fabric with only the PET weft (FIG. 2(a)). As noted above, and indicated in Table 2, the fabric with the malleable bottom weft yarn has to be worn approximately 30% more before the warp yarn can be exposed.

Thus, the present invention provides a monofilament made of polymer material blend that has surprisingly comparable mechanical and thermal properties (as shown below in Table 3). Table 3 compares the properties and monofilament processes of a control (made of 100% PET polymer and a monofilament composed of PET and 27% maleic anhydride modified ethylene copolymer. As demonstrated by these results, the monofilament has higher abrasion resistance measured by an industry flex type of abrasion tester. Furthermore, the monofilament is readily deformable at weaving and fabric making process if used as a weft material. The monofilament in the fabric protects the warp yarns from damage by abrasion and significantly extends the life of the fabric.

TABLE 3

| | Sample | |
|---|---|---|
| | Control | Experimental Sample |
| Main Resin | PET | PET |
| Additive | No | 27 wt. % |
| Melt Process Temp. (° C.) | 317 | 301 |
| Spin Pump Speed (RPM) | 24 | 24 |
| Die Pressure (psi) | 1200 | 750 |
| Linear Speed (FPM) | 80 | 80 |
| Draw Ratio | 4.0 | 4.0 |
| Draw Temp. (° C.) | 193 | 193 |
| Denier (grams/9000 m) | 2545 | 2380 |
| Tenacity (gpd) | 3.6 | 3.3 |
| Elongation at Break (%) | 50 | 45 |
| Modulus (gpd) | 74 | 71 |
| Elongation at 1.75 gpd force (%) | 12.1 | 15 |
| Loop Tenacity (gpd) | 6.7 | 6.3 |
| Loop Elongation at Break (%) | 45 | 40 |
| Flex Abrasion (cycles to break) | 7,000 | 7,500 |
| Free Shrinkage at 204° C. (%) | 10 | 12 |

It is noted that the foregoing examples have been provided merely for the purpose of explanation and are in no way to be construed as limiting of the present invention. While the present invention has been described with reference to a preferred embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

Further, when an amount, concentration, or other value or parameter, is given as a list of upper preferable values and lower preferable values, this is to be understood as specifically disclosing all ranges formed from any pair of an upper preferred value and a lower preferred value, regardless whether ranges are separately disclosed.

What is claimed is:

1. A yarn for an industrial fabric, comprising:
a polymeric material blend having at least a first phase and a second phase,
wherein the polymeric material blend exhibits shape malleability under heat from approximately 80° C. to approximately 300° C.

2. The yarn according to claim 1, wherein the first phase of the polymeric material blend contains a melting point higher than the melting point of the second phase of the polymeric material blend.

3. The yarn according to claim 2, wherein the first phase of the polymeric material blend comprises from approximately 60 to approximately 100 wt. % polyethylene terephthalate, and
the second phase of the polymeric material blend comprises from approximately 0 to approximately 40 wt. % of ethylene copolymer.

4. The yarn according to claim 1, further comprising at least one compatibilizer.

5. The yarn according to claim 4, wherein the at least one compatibilizer is present in the amount of from approximately 0.01 wt. % to approximately 10 wt. %.

6. The yarn according to claim 4, wherein the compatibilizer comprises at least one of Ethylene Methyl Acrylate Copolymer (EMA), Ethylene Butyl Acrylate Copolymer (EBA), Ethylene-g-Maleic Anhydride Copolymers, or Ethylene-g-Glycidal Methacrylate.

7. The yarn according to claim 1, further comprising at least one stabilizer.

8. The yarn according to claim 7, wherein the at least one stabilizer is present in the amount of from approximately 0.01 wt. % to approximately 10 wt. %.

9. The yarn according to claim 7, wherein the stabilizer comprises at least one carbodiimide compound.

10. An industrial fabric comprising:
warp yarns and weft yarns interwoven with each other,
wherein at least the weft yarns are constructed of a polymeric material blend having at least a first phase and a second phase such that the polymeric material blend exhibits shape malleability under heat from approximately 80° C. to approximately 300° C.

11. The industrial fabric according to claim 10, wherein the first phase of the polymeric material blend contains a melting point higher than the melting point of the second phase of the polymeric material blend.

12. The industrial fabric according to claim 11, wherein the first phase of the polymeric material blend comprises from approximately 60 to approximately 100 wt. % polyethylene terephthalate, and
the second phase of the polymeric material blend comprises from approximately 0 to approximately 40 wt. % of ethylene copolymer.

13. The industrial fabric according to claim 10, wherein the fabric is constructed to have a warp burial on a machine side of the industrial fabric of from approximately 0.01 mm to approximately 0.99 mm after a heat-set treatment of the industrial fabric from a temperature of approximately 80° C. to approximately 300° C.

14. The industrial fabric according to claim 10, wherein the fabric is constructed to have a warp burial on a machine side of the industrial fabric of from approximately 0.1 mm to approximately 0.7 mm after a heat-set treatment of the industrial fabric from a temperature of approximately 80° C. to approximately 300° C.

15. The industrial fabric according to claim 10, wherein the fabric is constructed to have a warp burial on a paper side of the industrial fabric of from approximately 0.01 mm to approximately 0.5 mm after a heat-set treatment of the industrial fabric from a temperature of approximately 80° C. to approximately 300° C.

16. The industrial fabric according to claim 10, wherein the fabric is constructed to have a warp burial on a paper side of the industrial fabric of from approximately 0.1 mm to approximately 0.4 mm after a heat-set treatment of the industrial fabric from a temperature of approximately 80° C. to approximately 300° C.

17. A method of making an industrial fabric comprising:
Providing warp yarns and weft yarns and interweaving them with respect to each other,
wherein at least the weft yarns are constructed of a polymeric material blend having at least a first phase and a second phase such that the polymeric material blend exhibits shape malleability under heat from approximately 80° C. to approximately 300° C.

18. The method of making an industrial fabric according to claim 17, wherein the first phase of the polymeric material blend contains a melting point higher than the melting point of the second phase of the polymeric material blend.

19. The method of making an industrial fabric according to claim 18, wherein the first phase of the polymeric material blend comprises from approximately 80 to approximately 100 wt. % polyethylene terephthalate, and
the second phase of the polymeric material blend comprises from approximately 0 to approximately 20 wt. % of ethylene copolymer.
